(19) United States
(12) Patent Application Publication
(10) Pub. No.: US 2024/0055210 A1
(43) Pub. Date: Feb. 15, 2024

(54) DISTRIBUTOR BLOCK AND METHOD FOR PRODUCING DISTRIBUTOR BLOCKS

(71) Applicant: PHOENIX CONTACT GMBH & CO. KG, Blomberg (DE)

(72) Inventor: Eugen SILBERNAGEL, Loehne (DE)

(21) Appl. No.: 18/042,470

(22) PCT Filed: Aug. 18, 2021
(86) PCT No.: PCT/EP2021/072870

§ 371 Date: Sep. 4, 2023

(30) Foreign Application Priority Data
Aug. 25, 2020 (BE) BE2020/5588

(51) Int. Cl. H01H 85/02; H01H 85/20

(52) U.S. Cl. CPC H01H 85/0241; H01H 85/205; H01H 85/2035; H01H 2085/2075

(57) ABSTRACT

A distributor block includes: a supply input having an input terminal for connecting an electrical conductor; and a plurality of outputs, each output of the plurality of outputs having an output terminal for connecting an electrical conductor. The supply input is electrically conductively connected to a first current bar. Each output is electrically conductively connected to a second current bar. Between the first current bar and the second current bar, a fuse and/or a switch is arranged to connect the first current bar to the second current bar. A receptacle configured to hold the fuse and/or the switch is provided between the first current bar and the second current bar.

### CROSS-REFERENCE TO PRIOR APPLICATIONS

This application is a U.S. National Phase application under 35 U.S.C. § 371 of International Application No. PCT/EP2021/072870, filed on Aug. 18, 2021, and claims benefit to Belgian Patent Application No. BE 2020/5588, filed on Aug. 25, 2020. The International Application was published in German on Mar. 3, 2022 as WO/2022/043141 under PCT Article 21(2).

### FIELD

The present invention relates to a distributor block and a method for producing distributor blocks.

### BACKGROUND

Distributor blocks serve to supply a plurality of outputs with electrical current or electrical power via a common supply input. The entire total current of all outputs is provided via the supply input. In this case, it can occur that the supply input is overloaded if a greater total current is output via the outputs than the dimensioning of the supply input provides. Furthermore, fluctuations in the total current, in particular a brief overload, can lead to damage to upstream or downstream electronic components.

### SUMMARY

In an embodiment, the present invention provides a distributor block, comprising: a supply input having an input terminal for connecting an electrical conductor; and a plurality of outputs, each output of the plurality of outputs having an output terminal for connecting an electrical conductor, wherein the supply input is electrically conductively connected to a first current bar, wherein each output is electrically conductively connected to a second current bar, wherein, between the first current bar and the second current bar, a fuse and/or a switch is arranged to connect the first current bar to the second current bar, and wherein a receptacle configured to hold the fuse and/or the switch is provided between the first current bar and the second current bar.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1A a schematic representation of a distributor block according to the invention in a perspective view from above,

FIG. 1B a schematic representation of the distributor block according to FIG. 1A in a view from below,

FIG. 2A a schematic representation of a further distributor block according to the invention in a perspective view from above,

FIG. 2B a schematic representation of the distributor block according to FIG. 2A in a view from below,

FIG. 3 a schematic representation of a further distributor block according to the invention in a perspective view from above,

FIG. 4 a flowchart of a method according to the invention,

FIG. 5A a schematic representation of a distributor block in a perspective view from above,

FIG. 5B a schematic representation of the distributor block according to FIG. 5A in a view from below.

### DETAILED DESCRIPTION

In an embodiment, the present invention provides a distributor block, which enables reliable and safe operation. Furthermore, a method for producing such distributor blocks is provided.

In an embodiment, the present invention provides a distributor block, with a supply input and a plurality of outputs, wherein the supply input has an input terminal for connecting an electrical conductor, wherein each of the outputs has an output terminal for connecting an electrical conductor, wherein the supply input is electrically conductively connected to a first current bar, wherein each of the outputs is electrically conductively connected to a second current bar, wherein a fuse and/or a switch for connecting the first current bar to the second current bar is arranged between the first current bar and the second current bar and wherein a receptacle for holding the fuse and/or the switch is provided between the first current bar and the second current bar.

By incorporating a fuse, the distributor block provides protection against overloading. Alternatively or additionally, with the aid of a switch the distributor block enables disconnection and connection of the first and second current bars.

The switch can be, for example, a circuit-breaker or residual current circuit-breaker (RCD).

A fuse or a plurality of fuses can be arranged in one or more receptacles between the first and second current bars.

Alternatively or additionally, a switch or a plurality of switches can be arranged in one or a plurality of receptacles between the first and second current bars.

It can be provided that the supply input and the first current bar are configured for transmitting a nominal current of more than 10 amperes and less than 50 amperes, for example at a nominal voltage of 450 volts.

It can be provided that the supply input and the first current bar are configured for transmitting a maximum total current of more than 30 amperes and less than 100 amperes.

It can be provided that the distributor block can be operated with a nominal voltage of 800 volts. In particular, the distributor block can be operated with a nominal voltage selected from a range of 100-1000 volts.

The receptacle can be riveted to the first current bar. Alternatively or additionally, the receptacle can be riveted to the second current bar. The first current bar and/or the second current bar can thus be used with and connected to different receptacles, wherein the distributor block can be provided in an application-specific manner with a receptacle for holding a specific fuse and/or a specific switch. For the design and manufacture of various derivatives of distributor blocks, this results in the advantage that current bars of identical design can be used with different receptacles and not have to be re-designed for each receptacle.

If, in the present case, “different” receptacles are mentioned, these will be receptacles which differ in their shape and/or dimensions.

Alternatively or additionally, it can be provided that the receptacle is welded to the first current bar and/or that the receptacle is welded to the second current bar. A reliable bonded connection can thus be created in order to ensure an electrical contact between the components welded together.

It can be provided that the receptacle is screwed to the first current bar and/or that the receptacle is screwed to the second current bar. A releasable connection can thus be made possible.

It can be provided that the receptacle is latched to the first current bar and/or that the receptacle is latched to the second current bar. A releasable, in particular force-fitting and/or form-fitting connection can thus be made possible.

The receptacle can have a first terminal lug which is configured to connect the receptacle to the first current bar, in particular, for example, by riveting and/or welding.

The receptacle can have a second terminal lug which is configured to connect the receptacle to the second current bar, in particular, for example, by riveting and/or welding.

The receptacle can be configured to hold a vehicle fuse. For example, this can be a type C vehicle fuse (e.g., according to ISO 8820-3; 2015-09). The receptacle can have a separation zone which is bridged by the contacts of the fuse, in order to connect the first and second current bars together in an electrically conductive manner.

The receptacle can alternatively be configured to hold a G-fuse (e.g., according to DIN EN 60127-1 VDE 0820-1:2015-12). The receptacle can have a socket for receiving the fuse, in order to connect the first current bar and the second current bar together in an electrically conductive manner.

The receptacle can alternatively be configured to hold a switch. This can be, for example, a residual current circuit-breaker in order to connect the first and second current bars together in an electrically conductive manner in a first switch position and to disconnect them from each other in a second switch position.

It can be provided that the first current bar has a larger conductor cross-section and/or a greater wall thickness than the second current bar. The first current bar can therefore be designed or dimensioned for reliably transmitting a total current which is output via the outputs.

For example, it can be provided that the first current bar has a wall thickness of 1 mm or more or has a wall thickness of at most 2 mm, in particular has a wall thickness of 1.1 mm, or that the second current bar has a wall thickness less than or equal to 1 mm, in particular has a wall thickness of 0.8 mm.

The first current bar can be a sheet metal component which has been produced from a sheet metal by forming and/or punching out.

The second current bar can be a sheet metal component which has been produced from a sheet metal by forming and/or punching out.

When wall thicknesses are mentioned in the present case, this can in particular be sheet metal thicknesses of a metal sheet provided in each case for producing the first and/or second current bar. It is understood that the first and second current bars can have been produced from different metal sheets which can have different sheet metal thicknesses. A first metal sheet from which the first current bar is manufactured can thus have a greater sheet metal thickness than a second metal sheet from which the second current bar is manufactured.

The first current bar and/or the second current bar can have a metallic material or consist of a metallic material.

The distributor block can in particular be designed according to a standard IEC 60947-7-1 and/or IEC 60998-2-2.

The distributor block can have, for example, exactly one supply input.

The distributor block can have more than four outputs, in particular have more than ten outputs, in particular have at most twenty outputs.

It can be provided that the supply input and/or the outputs are designed as push-in connections. Push-in connections enable a tool-free attachment of cable ends to the supply input and/or to the outputs.

The outputs can be configured to receive conductor cross-sections selected from a range of 0.14 mm²-4 mm², in particular to receive conductor cross-sections selected from a range of 0.34 mm²-2.5 mm². The supply input can be submitted in such a way that it can accommodate conductor cross-sections up to 16 mm².

The outputs can be arranged in two rows and/or mirror-symmetrically.

The supply input can be arranged with an offset to the outputs. The offset makes it possible in a simple manner to mount larger conductor cross-sections.

The supply input and the outlets can have openings for inserting conductors, which openings can be arranged on one side of a housing of the distributor block. The supply input and the outputs can thus be accessible, in particular, from one and the same side of the distributor block.

The invention further relates to a method for producing distributor blocks, comprising the method steps of: producing a first distributor block according to the invention, producing a second distributor block according to the invention, wherein the receptacle for holding the fuse and/or the switch of the first distributor block and the receptacle for holding the fuse and/or the switch of the second distributor block are not structurally identical and wherein the first current bar of the first distributor block and the first current bar of the second distributor block are structurally identical and/or wherein the second current bar of the first distributor block and the second current bar of the second distributor block are structurally identical.

For this reason, two distributor blocks with different receptacles can be manufactured, although structurally identical current bars can still be used.

In particular, it can be provided that, in a further method step, a third distributor block is produced which does not have a fuse and/or a switch or a receptacle for holding a fuse and/or a switch, wherein a first current bar of the third distributor block is structurally identical to the first current bar of the first and second distributor blocks and/or wherein a second current bar of the third distributor block is structurally identical to the second current bar of the first and second distributor blocks. Accordingly, structurally identical current bars can also be used for the production of distributor blocks which have no fuse and/or no switch.

The first and second current bars of the third distributor block can be riveted to each other. The first and second current bars of the third distributor block can be welded to each other. The first and second current bars of the third distributor block can be screwed to each other. The first and second current bars of the third distributor block can be latched to each other.

According to the invention, a modular system for producing distributor blocks can be specified, wherein structurally identical first current bars, depending on the application, can be connected to different receptacles, not structurally identical, in distributor blocks, in order to provide different distributor blocks according to the invention. Furthermore, it can be provided that structurally identical second current bars, depending on the application, can be connected to different receptacles, not structurally identical, in distributor blocks, in order to provide different distributor blocks according to the invention. Furthermore, it can be provided that first current bars can be connected to second current bars, in order to provide a distributor block without a fuse and/or switch.

In particular, it can be provided that the first current bar of a first distributor block according to the invention of the modular system comprises openings and/or recesses which in the preassembled state in a housing of the distributor block lie in relation to openings and/or recesses of a first receptacle substantially congruently above one another and/or engage with one another at least in sections, in order to predetermine the position of a riveted connection or a plurality of riveted connections.

In particular, it can be provided that the second current bar of the first distributor block according to the invention of the modular system comprises openings and/or recesses which in the preassembled state in a housing of the distributor block lie in relation to openings and/or recesses of the first receptacle substantially congruently above one another and/or engage with one another at least in sections, in order to predetermine the position of a riveted connection or a plurality of riveted connections.

In particular, it can be provided that the first current bar of a second distributor block according to the invention of the modular system comprises openings and/or recesses which in the preassembled state in a housing of the distributor block lie in relation to openings and/or recesses of a second receptacle that is different from the first receptacle substantially congruently above one another and/or engage with one another at least in sections, in order to predetermine the position of a riveted connection or a plurality of riveted connections. The first current bars of the first and second distributor blocks are structurally identical.

Furthermore, it can be provided that the second current bar of the second distributor block of the modular system has openings and/or recesses which in the preassembled state in a housing of the distributor block lie in relation to openings and/or recesses of the second receptacle that is different from the first receptacle substantially congruently above one another and/or engage with one another at least in sections, in order to predetermine the position of a riveted connection or a plurality of riveted connections. The second current bars of the first and second distributor blocks are structurally identical.

In particular, it can be provided that the first current bar of a third distributor block according to the invention of the modular system comprises openings and/or recesses which in the preassembled state in a housing of the distributor block lie in relation to openings and/or recesses of the second current bar substantially congruently above one another and/or engage with one another at least in sections, in order to predetermine the position of a riveted connection or a plurality of riveted connections. The first current bars of the first and third distributor blocks are structurally identical. The second current bars of the first and third distributor blocks are structurally identical.

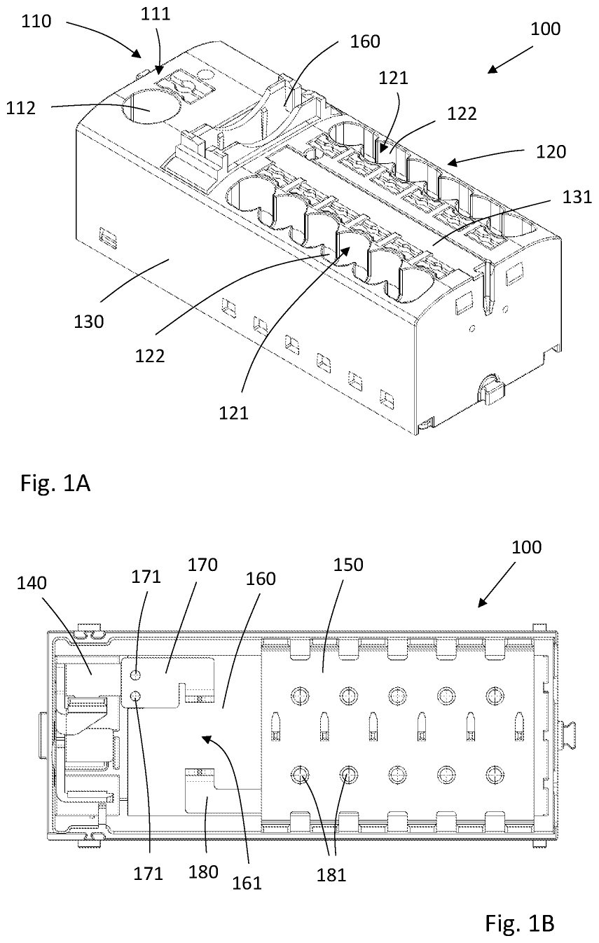

FIG. 1A shows a distributor block 100 with a supply input 110 and a plurality of outputs 120.

The supply input 110 has an input terminal 111 for connecting an electrical conductor. Each of the outputs 120 has an output terminal 121 for connecting an electrical conductor.

An opening 112 in the supply input 110 for introducing a conductor end of an electrical conductor is assigned to the input terminal 111. The input terminal 111 extends into a housing 130 of the distributor block 100 and clamps a conductor end inside the housing 130 in the region of the opening 112, in order to fasten the conductor to the distributor block 100. For this reason, only that part of the input terminal 111 which can be actuated with a tool, such as a screwdriver or the like, in order to release a fastened conductor, can be seen, wherein this is the actuating element, also called a pusher. Here, the supply input 110 or the input terminal 111 is designed as a push-in connection.

An opening 122 of the respective output 120 for inserting a conductor end of an electrical conductor is assigned to each output terminal 121. The output terminal 121 extends into the housing 130 of the distributor block 100 and clamps a conductor end inside the housing 130 in the region of the opening 122, in order to fasten the conductor to the distributor block 100. For this reason, only that part of the respective output terminal 121 which can be actuated to release a fastened conductor with a tool, such as a screwdriver or the like, can be seen. Each output 120 or each output terminal 121 is designed as a push-in connection.

The supply input 110 is electrically conductively connected to a first current bar 140.

Each output 120 is electrically conductively connected to a second current bar 150.

A receptacle 160 for holding a fuse is arranged between the first current bar 140 and the second current bar 150. In the present case, the receptacle 160 is provided for holding a type C vehicle fuse.

The receptacle 160 forms a separation zone 161 or an air gap 161, so that the current bars 140, 150 are separated from each other by the separation zone 161 or the air gap 161, as long as there is no fuse seated in the receptacle 160, as shown in FIG. 1B.

When a fuse is inserted into the receptacle 160, the fuse with its contacts establishes an electrically conductive connection between the first current bar 140 and the second current bar 150. For this purpose, a first contact of the fuse abuts a first terminal lug 170 of the receptacle 160 and a second contact of the fuse abuts a second terminal lug 180 of the receptacle 160.

Two riveted connections 171 are formed between the terminal lug 170 and the first current bar 140.

Two riveted connections 181 are formed between the terminal lug 180 and the second current bar 150.

In the present case, the first current bar 140 has a larger conductor cross-section and a greater wall thickness than the second current bar 150.

The first current bar 140 has a wall thickness of 1.1 mm. The second current bar 150 has a wall thickness less than or equal to 1 mm.

The distributor block 100 has exactly one supply input 110 and twelve outputs 120.

The outputs 120 are arranged in two rows and mirror-symmetrically.

The supply input 110 is arranged with an offset to the outputs 120.

The supply input 110 and the outputs 120 are arranged with their openings 112, 122 and terminals 111, 121 on a common side 131 of the housing 130 of the distributor block 100.

The side 131 can also be referred to as the upper side 131 and faces away from a lower side 132 of the housing 130 in which sections of the current bars 140, 150 are arranged.

The housing 130 has an electrically insulating plastic, in the present case polyamide.

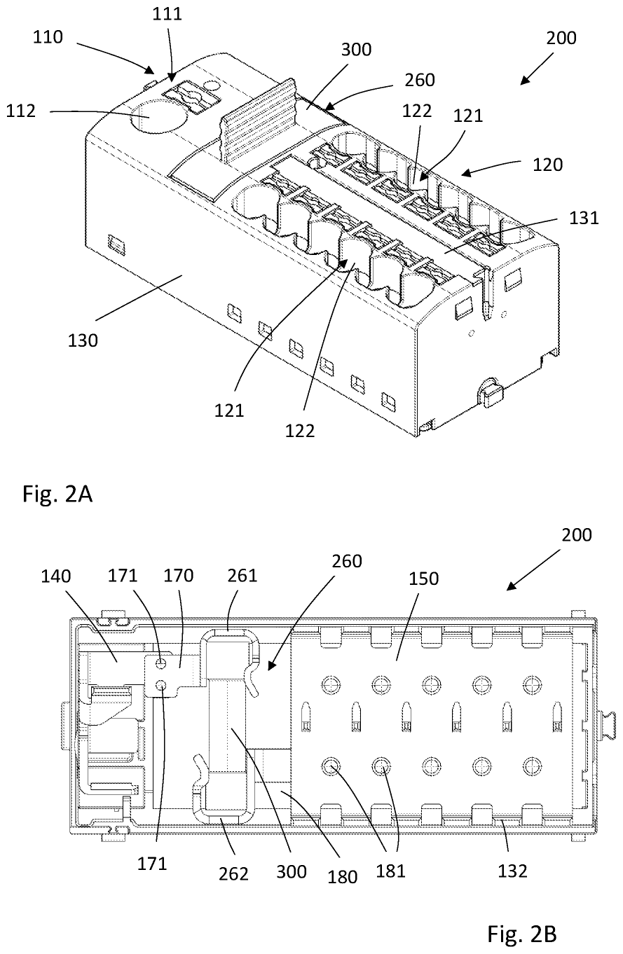

FIGS. 2A and 2B show a further variant of a distributor block 200. To avoid repetition, only the differences from the exemplary embodiment described above will be discussed, with the same features being assigned the same reference numerals.

The distributor block 200 differs from the exemplary embodiment described above in that a receptacle 260 for holding a G-fuse 300 is provided. Accordingly, the fuse 300 is arranged between the first current bar 140 and the second current bar 150, in order to connect the first current bar 140 and the second current bar 150 electrically conductively to each other.

The receptacle 260 has a first socket 261 for holding the fuse 300. The receptacle 260 has a second socket 262 for holding the fuse 300.

The first socket 261 is electrically conductively connected to the terminal lug 170 of the receptacle 260. The second holder 262 is electrically conductively connected to the terminal lug 180 of the receptacle 260.

The first holder 261 is formed integrally with the terminal lug 170.

For the distributor block 100 and the distributor block 200, structurally identical first current bars 140 and structurally identical second current bars 150 can accordingly be used, which are connected via riveted connections 171, 181 to the terminal lugs 170, 180. The current bars 140, 150 are therefore only connected to different receptacles 160, 260, in order to use different fuses in the distributor blocks 100, 200.

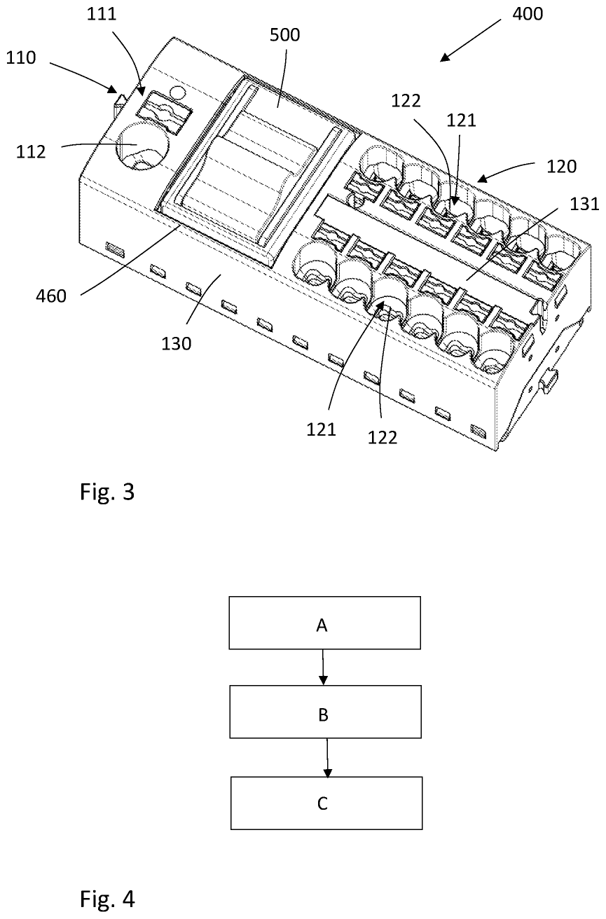

FIG. 3 shows a further variant of a distributor block 400. To avoid repetition, only the differences from the exemplary embodiments described above are discussed, with the same features being assigned to the same reference numerals.

The distributor block 400 differs from the exemplary embodiments described above in that a receptacle 460 is provided between the current bars and is configured to hold a switch 500.

The switch 500 is used to connect and disconnect an electrically conductive connection between the current bars 140, 150.

Again, a first current bar 140, which is structurally identical to those of the distributor blocks 100, 200, has been used for the distributor block 400. Furthermore, a second current bar 150 which is structurally identical to those of the distributor blocks 100, 200 has been used for the distributor block 400.

In the present case, the switch 500 is a residual current circuit-breaker.

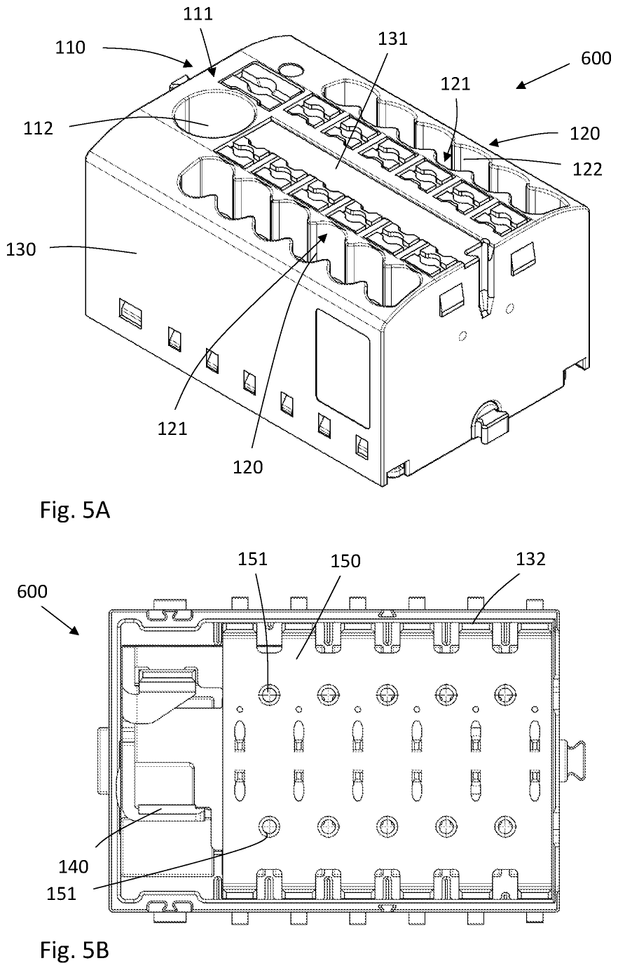

According to FIG. 4, a method for producing distributor blocks is described, comprising the method steps of:
A) producing a first distributor block, wherein the distributor block is a distributor block 100 according to FIG. 1A,
B) producing a second distributor block, wherein the distributor block is a distributor block 200 according to FIG. 2A,
   wherein the receptacle 160 for holding the fuse of the first distributor block 100 and the receptacle 260 for holding the fuse 300 of the second distributor block 200 are not structurally identical and
   wherein the first current bar 140 of the first distributor block 100 and the first current bar 140 of the second distributor block 200 are structurally identical and wherein the second current bar 150 of the first distributor block 100 and the second current bar 150 of the second distributor block 200 are structurally identical,
C) producing a third distributor block, wherein the distributor block is a distributor block 400 according to FIG. 3 or is a distributor block 600 according to FIG. 5A.

The distributor block 600 according to FIG. 5A has neither a fuse nor a switch. Here, the first current bar 140 and the second current bar 150 are directly riveted together, as the riveted connections 151 in FIG. 5B show. Again, a first current bar 140, which is structurally identical to those of the distributor blocks 100, 200, 400, has been used for the distributor block 600. Furthermore, for the distributor block 600, a second current bar 150 has been used, which is structurally identical to those of the distributor blocks 100, 200, 400.

Accordingly, a modular system for producing distributor blocks 100, 200, 400, 600 can be specified, wherein structurally identical first current bars 140, depending on the application, can be connected to different receptacles 160, 260, 460, which are not structurally identical, in distributor blocks 100, 200, 400, in order to provide different distributor blocks 100, 200, 400 according to the invention.

Furthermore, it can be provided that structurally identical second current bars 150, depending on the application, can be connected to different receptacles 160, 260, 460, which are not structurally identical, in distributor blocks 100, 200, 400, in order to provide different distributor blocks 100, 200, 400 according to the invention.

Furthermore, it can be provided that the first current bar 140 can be connected to the second current bar 150, in order to provide a distributor block 600 without a fuse and/or a switch.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Distributor block
110 Supply input
111 Input terminal
112 Opening
120 Output
121 Output terminal
122 Opening
130 Housing
131 Side/upper side
132 Underside
140 First current bar
150 Second current bar
151 Riveted connection
160 Receptacle
161 Separation zone, air gap
170 Terminal lug
171 Riveted connection
180 Terminal lug
181 Riveted connection
200 Distributor block
260 Receptacle
261 First socket
262 Second socket
300 G-fuse
400 Distributor block
460 Receptacle
500 Switch
600 Distributor block

1: A distributor block, comprising:
a supply input having an input terminal for connecting an electrical conductor; and
a plurality of outputs, each output of the plurality of outputs having an output terminal for connecting an electrical conductor,
wherein the supply input is electrically conductively connected to a first current bar,
wherein each output is electrically conductively connected to a second current bar,
wherein, between the first current bar and the second current bar, a fuse and/or a switch is arranged to connect the first current bar to the second current bar, and
wherein a receptacle configured to hold the fuse and/or the switch is provided between the first current bar and the second current bar.

2: The distributor block of claim 1, wherein the receptacle is riveted to the first current bar and/or that the receptacle is riveted to the second current bar.

3: The distributor block of claim 1, wherein the receptacle is welded to the first current bar, and/or
wherein the receptacle is welded to the second current bar.

4: The distributor block of claim 1, wherein the fuse comprises a vehicle fuse, or
wherein fuse comprises a G-fuse.

5: The distributor block of claim 1, wherein the first current bar has a larger conductor cross-section and/or a greater wall thickness than the second current bar.

6: The distributor block of claim 5, wherein the first current bar has a wall thickness of 1 mm or more or has a wall thickness of at most 2 mm, or
wherein the second current bar has a wall thickness less than or equal to 1 mm.

7: The distributor block of claim 1, wherein the distributor block has exactly one supply input and/or the distributor block has more than four outputs.

8: The distributor block of claim 1, wherein the supply input and/or the outputs comprise push-in connections.

9: The distributor block of claim 1, wherein the outputs are arranged in two rows and/or mirror-symmetrically and the supply input is arranged with an offset to the outputs, and/or
wherein the supply input and the outputs have openings for inserting conductors disposed on one side of a housing of the distributor block.

10: A method for producing distributor blocks, comprising:
producing a first distributor block of and a second distributor block of claim 1;
wherein the receptacle for holding the fuse and/or the switch of the first distributor block and the receptacle for holding the fuse and/or the switch of the second distributor block are not structurally identical, and
wherein the first current bar of the first distributor block and the first current bar of the second distributor block are structurally identical, and/or
wherein the second current bar of the first distributor block and the second current bar of the second distributor block are structurally identical.

11: The distributor block of claim 6, wherein the wall thickness of the first current bar is 1.1 mm, or
wherein the wall thickness of the second current bar is 0.8 mm.

12: The distributor block of claim 7, wherein the distributor block has more than four outputs, and
wherein distributor block has more than ten outputs.

13: The distributor block of claim 12, wherein the distributor block has at most twenty outputs.
